(19) United States
(12) Patent Application Publication
(10) Pub. No.: US 2025/0028189 A1
(43) Pub. Date: Jan. 23, 2025

(54) OPHTHALMIC LENS INCLUDING A SPATIALLY-MODULATED OPTICAL POWER PROFILE

(71) Applicant: Bausch + Lomb Ireland Limited, Dublin (IE)

(72) Inventors: Alexander KOTELSKY, Rochester, NY (US); Kristen HOVINGA, Honeoye Falls, NY (US)

(21) Appl. No.: 18/355,907

(22) Filed: Jul. 20, 2023

(51) Int. Cl. G02C 7/04

(52) U.S. Cl. CPC G02C 7/044; G02C 7/042; G02C 2202/24

(57) ABSTRACT

An ophthalmic lens having a central zone and a peripheral zone. The central zone having a first region characterized by a substantially constant first optical power and a second region disposed radially outward of the first region having periodic positive and negative deviations in power as a function of radial position, relative to the substantially constant first power. The peripheral zone disposed radially outward of the central zone. The peripheral zone having periodic positive and negative deviations relative to an average optical power, the average optical power increasing as a function of radius from the first power.

### FIELD

Methods and apparatus for reducing or eliminating myopia progression including an ophthalmic lens, and more particularly methods and apparatus for reducing or eliminating myopia progression including an ophthalmic lens with a spatially-modulated optical power profile.

### BACKGROUND

Myopia is a condition of the eye resulting in objects at a far distance (e.g., greater than six meters) being focused in front of the retina, thereby causing blurred vision. Myopia is normally corrected with the use of an ophthalmic lens of sufficient negative power to bring distant objects into focus on the central retina, while allowing near objects to be focused on the central region of the retina by accommodation of the crystalline lens of the eye.

Most commonly, myopia occurs when eye growth is excessive, resulting in an imbalance between the axial length of the eye relative to focal power of the eye. Myopia is commonly a progressive disorder associated with gradual elongation of the eye. A number of undesirable pathologies (e.g., retinal detachment and glaucoma) potentially leading to vision loss may occur as a result of eye elongation arising from progressive myopia.

It is now generally accepted that increases in axial length of an eye of a growing animal is controlled by a feedback mechanism that occurs within the eye, which allows light entering the eye to be focused onto the central region of the retina (i.e., within about 2 degrees of the visual axis). In an emmetropic eye, this mechanism works well, and axial length and focal power of the eye remain in balance allowing for light to be focused onto the central region of the retina as the eye grows; however, in a myopic eye, the elongation is excessive and, in a hyperopic eye, elongation is insufficient, both situations resulting in poorly focused light being projected onto the central region of the retina.

Multiple theories exist regarding the feedback mechanism of the eye, any or all of which may contribute to a given patient's myopic progression. According to one theory, the axial location of the peripheral image controls eye growth. More particularly, under this theory, a stimulus for increased eye length is created when the peripheral focal plane of an eye lies behind (i.e., posterior to) the retina thereby causing peripheral hyperopic defocus.

While conventional single vision spectacles or contact lenses correct myopic defocus in the central retina, they may induce hyperopic defocus in periphery, and thereby stimulate eye growth. In addition, in children having myopia, during near-work tasks, peripheral hyperopic defocus may result from accommodative lag (i.e., under-accommodation). That is, because the eye does not accommodate sufficiently, a hyperopically defocused image is present in the periphery of the retina and the eye is stimulated to grow to achieve focus.

Conventionally, to address peripheral hyperopic defocus, a multizonal ophthalmic lens to control myopia progression is provided with a peripheral zone having a refractive add-power offset relative to the central zone of the lens to shift the focal plane in front of (i.e., anterior to) the peripheral retina.

Lenses designed to control peripheral focus are constructed such that visual rays (i.e., rays forming perceivable visual images) primarily pass only through a central zone of such a multizonal lens, and the peripheral zone is located radially outward of the central zone so as to primarily direct myopically shifted light outside of the central, visual region of the retina. Accordingly, if the central zone is configured for single vision, given normal accommodation of an eye, only an image formed by the central zone will be focused on the retina and light passing through the peripheral zone will be focused in front of the retina. At a given time, the image formed by the central zone can be of a distant object or a near object depending on the accommodative state of the eye.

Multizonal lenses having a peripheral zone with an add-power offset relative to the central zone are understood to be distinct from multizonal, bifocal (or multifocal) contact lenses where a central zone and an outer zone of the lens overlie the pupil such that a visually significant amount of visual rays intercept both the central zone and the outer zone. In bifocal lenses, because the outer zone has a different power than the central zone, visual rays from the central and outer zones form two images on the central retina at all times (one corresponding to distant objects and one corresponding to nearer objects, as determined by the focal powers of the zones). Typically, a bifocal (or a multifocal) lens is worn by a presbyopic (i.e., non-accommodating) wearer and the wearer's neural system is required to identify information regarding the relevant image.

According to another theory regarding the feedback mechanism of the eye, myopia progression is caused by or enhanced by a lack of uniform through-focus blur orientation in peripheral fields. In other words, the size and/or shape of the caustic changes as the light progresses in an axial direction relative to the retina, such that the blur in front of the retina is different than blur behind the retina. Under this theory, such non-uniformity gives a directional signal that triggers eye growth.

While lenses providing peripheral myopic defocus have been shown to be effective in achieving suppression of myopia progression for some wearers, other wearers have not achieved the desired suppression. Additionally, some wearers using conventional lenses providing peripheral myopic defocus have had their vision compromised by disturbances (e.g., glares and halos) resulting from stray light passing through the peripheral zone of the lens.

### SUMMARY

It is believed that the lack of efficacy for some wearers of conventional lenses designed to suppress the progression of myopia using a peripheral zone add-power offset results from a failure of conventional lenses to sufficiently address multiple or all stimuli of growth (e.g., hyperopic peripheral image formation and non-uniform through-focus blur orientation).

Aspects of the present invention are directed to a multizonal ophthalmic lens comprising a central zone for forming an image on the central retina and a peripheral zone having a power profile to provide an add-power offset relative to a central zone.

The central zone comprises a radially inward portion that has a substantially constant optical power and a radially outward portion that has an average power that is equal to the substantially constant power but that varies (as a function of radial position) relative to the substantially constant power due to a spatially-modulated power profile. The peripheral zone, which also has spatially-modulated power profile, has an average power that increases as a function of radial position from a value equal to the substantially constant power at the central zone-peripheral zone interface, to a value greater than the substantially constant power, at the outer edge of the peripheral zone. The term “average optical power” is to be understood as being analogous to a DC-component of the optical power as function of radius if optical power as function of radius were considered as an electrical signal; and the variations in optical power are to be understood as being analogous to a AC-component of the optical power as function of radius.

As indicated above, the optical power in the peripheral zone and the radially outward portion of the central zone have a spatially-modulated optical power profile. In the radially outward portion of the central zone, the spatial modulation occurs as alternating positive and negative deviations in optical power about the substantially constant power; and in the peripheral zone the spatial modulation occurs as alternating positive and negative deviations about the increasing average power. Typically, the deviations in the radially outward portion of the central zone and the peripheral zone form a continuous power profile.

As progressive myopia most commonly afflicts children and young adults, the diameter of the central zone of lenses according to aspects of the present invention may be greater than about 3 mm to reasonably ensure that the central zone is larger than a typical wearer's pupil under photopic conditions. However, as is understood in the art, due to the existence of what is known as the Stiles-Crawford effect, light rays that pass closer to the outer radial portions of the visual image forming portion of the eye (also called “peripheral rays”), have less visual significance than those rays that travel nearer the center of the pupil. Thus, the central zone need not be greater than the pupil diameter of the eye to be effective. Accounting for the Stiles-Crawford effect, it is typically desirable that the radius of a central zone of a lens be no more than 1 mm smaller than the radius of the pupil of a wearer's eye (e.g., 2 mm in diameter) or greater.

As is understood in the art, lenses are typically not custom-made for a wearer. Accordingly, lenses may be designed such that a central zone diameter of a lens is not more than 1 mm less than a normal (i.e., average) pupil diameter of an eye of any selected population.

An aspect of the invention is directed to an ophthalmic lens comprising a central zone and a peripheral zone. The central zone has a first region characterized by a substantially constant first optical power and a second region disposed radially outward of the first region having positive and negative deviations in power as a function of radial position, relative to the substantially constant first power. The peripheral zone is disposed radially outward of the central zone, the peripheral zone having positive and negative deviations as a function of radial position, relative to an average optical power, the average optical power increasing as a function of radius from the substantially constant first optical power.

In some embodiments, the substantially constant first optical power of the first region, the positive and negative deviations of the second region as a function of radius, and the positive and negative deviations of peripheral zone constitute a power profile, the power profile having no discontinuities in power.

In some embodiments, the diameter of the central zone is at least 2 mm or at least 3 mm. The central zone and/or the peripheral zone may be rotationally symmetric.

The lens may be a contact lens or another type of lens.

The positive and negative deviations in power of at least one of the second region and the peripheral zone may be periodic as a function of radius.

In some embodiments, in a plot of the power profile, the area above the constant first power and the average power that is encompassed by the positive deviations is less than 20% different than the area below the constant first power and the average power that is encompassed by the negative deviations.

In some embodiments, the (maximum) deviation amplitude relative to the average optical power of the peripheral zone is equal to the (maximum) deviation amplitude relative to the substantially constant first power in the second region. In some embodiments, the positive deviations and the negative deviations in the peripheral zone have an amplitude in the range of 0.5-12.0 diopters.

The average optical power in the peripheral zone may increase linearly.

In some embodiments, the positive deviations and the negative deviations in the second region (of the central zone) and in the peripheral zone are determined by variations in surface curvature.

Embodiments of any of the above lens structures can be embodied as contact lens or any other ophthalmic lens.

These and other aspects of the present invention will become apparent upon a review of the following detailed description and the claims appended thereto.

The term “greater” and the term “add-power offset” as used herein mean that an identified value (e.g., an optical power) is more positive than or less negative than a specified reference value. For example, a peripheral power may be greater than a central zone power. Alternatively, it may be stated that the peripheral power has an add-power offset relative to the central zone power.

One measure of uniformity of the through-focus blur (i.e., point spread function) is blur log orientation slope (BLOS), which measures how the size and shape of a caustic change as the light rays forming the caustic progress in an axial direction. As is further elucidated below, smaller values of BLOS indicate a higher uniformity of the through-focus blur orientation.

For example, BLOS is calculated as set forth in Through-Focus Optical Characteristics of Monofocal and Bifocal Soft Contact Lenses Across the Peripheral Visual Field, by Qiuzhi, et al., in The Authors Ophthalmic & Physiological Optics 38 (2018). The subject of said article is hereby incorporated by reference in its entirety. BLO may be determined based on calculations using rays constituting a caustic or calculations using pixels constituting a caustic if the pixel calculations are weighted based on pixel intensity, where pixels having greater intensity are given a commensurately greater weight which corresponds to light energy measured by each pixel.

### BRIEF DESCRIPTION OF THE DRAWINGS

FIG. 1A is a schematic plan view of an example of an ophthalmic lens according to aspects of the present invention;

FIG. 1B is a schematic cross-sectional view of the lens of FIG. 1A taken along line 1B-1B of FIG. 1A;

FIG. 2A illustrates one example of a power profile of an ophthalmic lens having spatial-modulation of optical power in a portion of the central zone and in a peripheral zone;

FIG. 2B illustrates examples of characteristics of a power profile that may be varied to balance myopia progression suppression efficacy, visual acuity, and wearer comfort;

FIGS. 3A-3C are graphical illustrations showing the effects of changing wave amplitude on normalized visual acuity (i.e., normalized with respect to a spectacle baseline), peripheral myopic defocus, and blur orientation slope (BLOS), respectively;

FIGS. 4A-4C are graphical illustrations showing the effects of changing slope of average power in the peripheral zone on normalized visual acuity, peripheral myopic defocus, and BLOS, respectively; and

FIGS. 5A-5C show the effects of changing width (i.e., radius) of the portion of the central zone having no periodic deviation in power on normalized visual acuity, peripheral myopic defocus, and BLOS, respectively.

### DETAILED DESCRIPTION

Aspects of the invention will be further illustrated with reference to specific examples. It is understood that these examples are given by way of illustration and are not meant to limit the scope of the claims to specific examples.

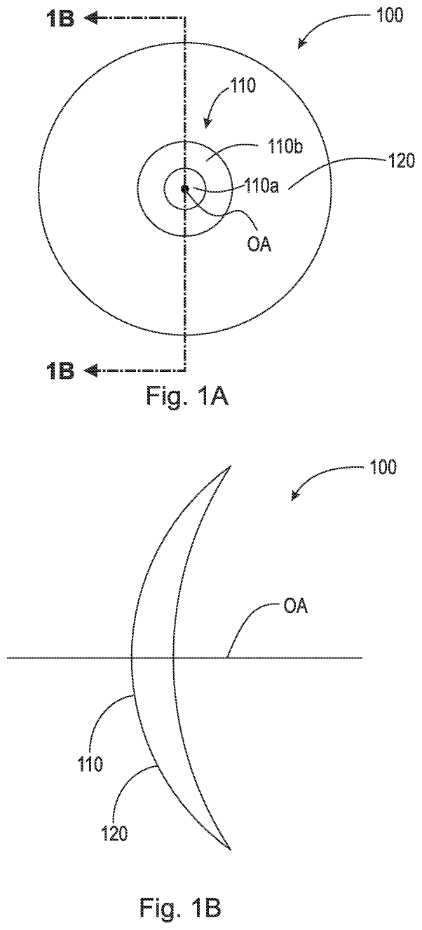

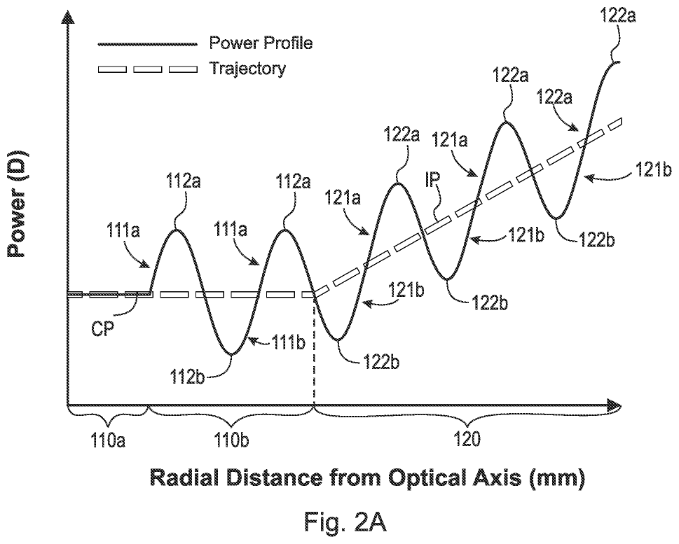

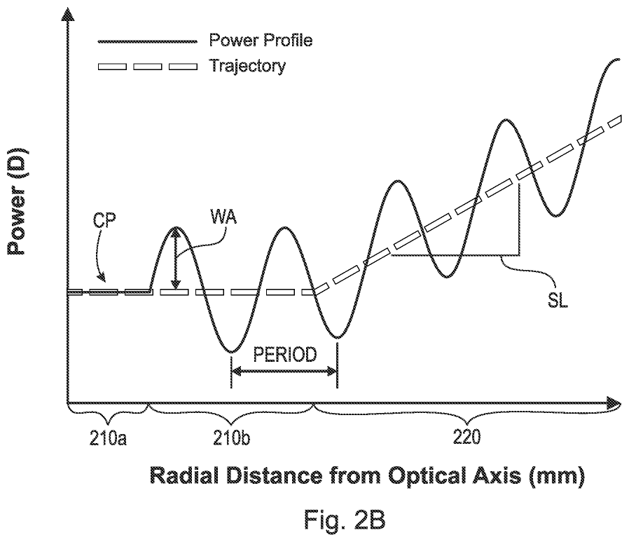

FIGS. 1A, 1B are schematic illustrations of an example of an ophthalmic lens according to aspects of the present invention; and FIG. 2A is a graphical illustration of one example of a power profile for use in an ophthalmic lens, in which optical power in a portion of the central zone and in a peripheral zone is spatially-modulated according to aspects of the present invention.

Ophthalmic lens 100 comprises an optical axis OA, a central zone 110 and a peripheral zone 120. Although in the illustrated embodiment the central zone and peripheral zone are rotationally symmetric and the lens has an optical axis OA aligned with the mechanical axis of the lens, deviation from such arrangements is possible. Also, although ophthalmic lens 100 is illustrated as a contact lens, lenses according to aspects of the invention may be embodied as other kinds of ophthalmic lenses. For example, a lens may be a corneal inlay, a corneal onlay or an intraocular lens.

Central zone 110 has a first region 110a characterized by a substantially constant first optical power CP and a second region 110b disposed radially outward of first region 110a having positive and negative deviations in power 111a, 111b as a function of radial position, relative to the substantially constant first power CP.

First region 110a typically has a power that is constant to within manufacturing

tolerances and the presence of any spherical aberration. The first region 110a is designed to achieve optimal vision correction using conventional techniques. Typically, achieving optimal vision corrections, means that the central zone is corrected for distance vision.

Second region 110b has positive and negative deviations in power 111a, 111b as a function of radial position, relative to the substantially constant first power. The radial power profile in the second zone includes at least one maxima 112a and at least one minima 112b. That is to say, the power is modulated as a function of radial position to achieve power of varying magnitude in a radial direction along the second region. The deviation may occur in a pattern of a specific period.

The deviations 111a, 111b function to provide extended depth of focus to a wearer thus alleviating any accommodative lag, which reduces eye strain. Additionally, deviations 11la, 111b may contribute to reduction in stimulus leading to progressive myopia. For example, the presence of deviations in the central zone contributes to peripheral myopic defocus for light entering the eye at an angle relative to the optical axis.

As stated above, because progressive myopia most commonly afflicts children and young adults, the diameter of central zone 110 of lenses according to aspects of the present invention will typically be greater than about 3 mm to reasonably ensure that the central zone is larger than a wearer's pupil under photopic conditions. However, according to the Styles-Crawford effect, light rays that pass close to the edge of visual image forming portion of the eye as they progress toward the retina have less visual significance than those rays that travel nearer the center of the pupil; thus, the central zone need not be equal to or greater than the pupil diameter of the eye to be effective. Accounting for the Stiles-Crawford effect, it is typically desirable that a central zone is not more than 1 mm smaller than the diameter of the pupil of a wearer's eye. For example, the central zone may have a diameter of at least 2.0 mm or a diameter of at least 3.0 mm or a diameter of at least 4.0 mm. The diameter of the central zone will typically be in the range 2.5 to 6.0 mm and chosen (in part) to reduce or avoid visual disturbances in a given population during selected lighting conditions.

Peripheral zone 120 is disposed radially outward of central zone 110, the peripheral zone having positive deviations 121a and negative deviations 121b relative to an average optical power IP, the average optical power IP increasing as a function of radius from the first power CP. While it is typically advantageous that the peripheral zone be radially outward of the central zone at all azimuthal angle values, peripheral zone 120 may be disposed radially outward from the central zone over substantially all 360 degrees of azimuthal angle. The peripheral zone has an increasing average power as function of radial position. The deviation amplitude (also referred to herein as a wave amplitude) in the peripheral zone 120 may be the same as or different than the wave amplitude in second regions 110b.

The optical power across the central zone-peripheral zone interface varies continuously, thereby avoiding a discontinuity in power and any visual disturbance (i.e., spurious directing of light into the visual portion of the retina) associated with a discontinuity in power. As shown in the embodiment of FIG. 2A, the average optical power may increase linearly as function of radial position; however, in some embodiments, the peripheral zone may have one or more regions of relatively large or small increases in optical power. It will be appreciated that the increase in peripheral zone power relative to the central zone addresses one stimulus of progressive myopia, namely peripheral hyperopic defocus.

Radial power may be varied using variations in surface curvature or variations in index of refraction. Similar to second region 110b of the central region, the radial power profile of peripheral zone 220 includes at least one maxima 122a and at least one minima 122b. That is to say, the power is modulated in the radial direction to achieve power of varying magnitude along the peripheral zone. The deviation may occur periodically (i.e., a repeating pattern having a fixed period) or aperiodically.

Although positive and negative deviations are embodied as a sinusoidal pattern in optical power about the first power CP and average power IP, it will be appreciated that other deviation patterns may be used. For example, the positive and negative deviations may be embodied as a triangular pattern or a sinusoidal shape approximated by linear portions. It is typically advantageous that the optical power is continuous as a function of radial position from optical axis OA to the outer boundary of the peripheral zone. The amplitudes of the deviations may be constant as a function of radial position or may increase and/or decrease as a function of radial position. It is typically advantageous if the area above the constant power CP and average optical power IP that is encompassed by the positive deviations is substantially equal (e.g., less than 20% different or less than 10% different) the area below the constant power CP and average optical power IP curve that is encompassed by the negative deviations, to contribute to the uniformity of the defocused blur generated by lens 100.

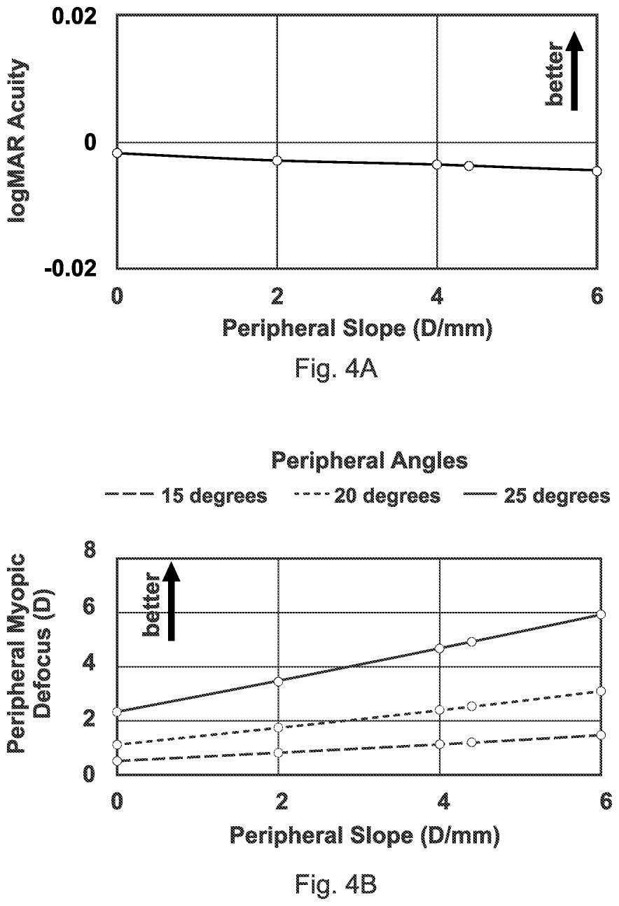

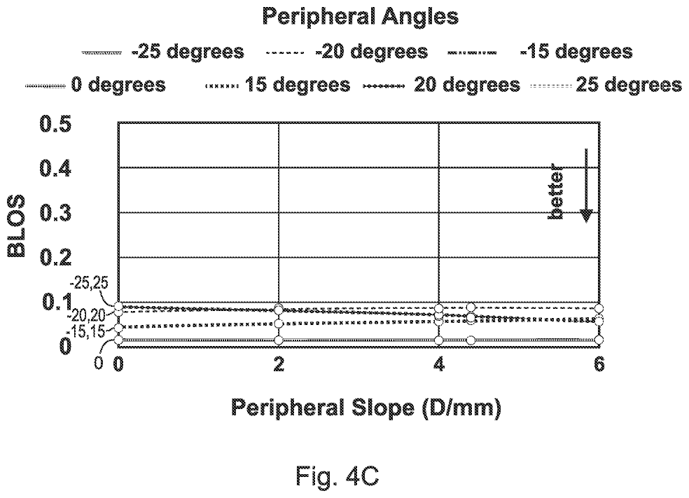

FIG. 2B illustrates examples of characteristics of a power profile that may be varied to balance myopia progression suppression efficacy, visual acuity and wearer comfort (i.e., a willingness of a wearer to tolerate wearing a lens for an extended period of time). As shown, various characteristics of a power profile of a lens having a central zone and peripheral zone each with a spatially-modulated power profile as described with reference to FIG. 2A can be selected to achieve myopia progression suppression while maintaining adequate vision (as perceived by a wearer) and wearer comfort. As discussed in greater detail below, suppression of myopia progression and visual acuity can be tested using an eye model in optical design software and/or by clinical testing. For example, lens design variables of lenses according to aspects of the present invention and their impacts on visual performance include the following.
The radius of the central zone region 210a having substantially constant power CP—an increase in the radius generally increases the visual acuity but decreases the depth of focus of the lens.
Wave amplitude WA—an increase in wave amplitude in the central zone increases depth of focus but decreases visual acuity. An increase in WA in the peripheral zone increases peripheral myopic defocus and decreases BLOS.
Slope SL of average power IP in the peripheral zone—an increase in slope increases peripheral defocus but has no significant effect on BLOS, visual acuity or depth of field within the range of slopes illustrated in FIGS. 4A-4C.
Radial extent of central zone second region 210b having periodic deviations in power—increasing the width of this portion of the central zone (at the expense of the peripheral zone) will increase depth of focus thereby addressing accommodative lag but will limit the peripheral myopic shift.
Wave shape (decaying as a function of radial position, rising as a function of radial position, a combination of decaying and rising, etc.) and wave frequency—by selecting the maxima and minima of the periodic deviation (as a function of radial position) the strength of suppression of myopia versus the comfort of wearing the lens can be affected. As discussed above, according to the Styles-Crawford effect, light from radial locations further from the visual axis has less visual impact; however, such light can still provide suppression of myopia progression. Accordingly, in some designs, it may be desirable to have deviation amplitude increase as a function of the radial position. Additionally, wave shape and frequency can impact light scattering and presence of any halos perceived by a wearer.

The deviations in power relative to the substantially constant power in the central zone or relative to the increasing average optical power in the peripheral zone will typically have a maximum amplitude in the range of about 0.5 diopters to about 12.0 diopters or a range of about 2.0 diopters to about 10.0 diopters. The embodiments according to FIGS. 2A-2B have central zones and peripheral zones that are rotationally symmetric or may also have variations of optical power in the circumferential direction.

Performance of an ophthalmic lens design can be modeled by locating a contact lens design in or on a model eye in ray trace software such as OpticStudio from Zemax LLC of Kirkland, WA. For example, a contact lens can be located on a model eye such as the Arizona eye or a representation of one or more measured eyes of human subjects. In one embodiment (referred to below as Embodiment 1), a nominal contact lens design has the following parameters:
A peripheral zone surrounds a central zone.
Wave shape of the deviation is sinusoidal, with uniform peak amplitude across the second region of the central zone and the peripheral zone.
Wave amplitude=4.0D
Wave period=0.89 mm
Slope of average power in the peripheral zone =4.4D/mm
Central zone radius=2.0 mm
Radius of the portion of the central zone having no periodic deviation in power =0.668 mm
Central zone average power=-3.0D
Peripheral zone outer radius=4.5 mm

To obtain a given lens design, a lens center thickness, and back surface radius and conic value were fixed and the anterior surface was fit with a aspheric surface where radius, conic, and surface parameters were allowed to vary to obtain a selected power profile.

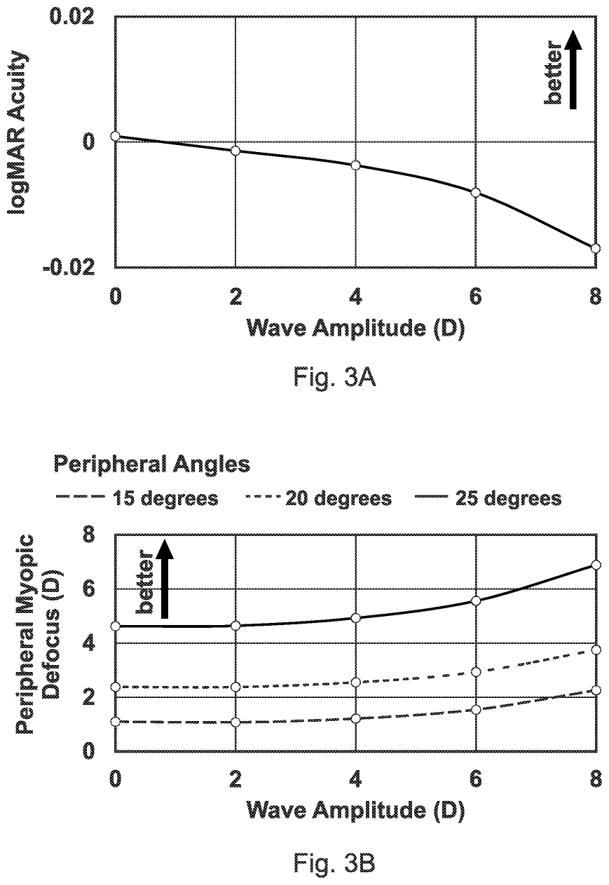

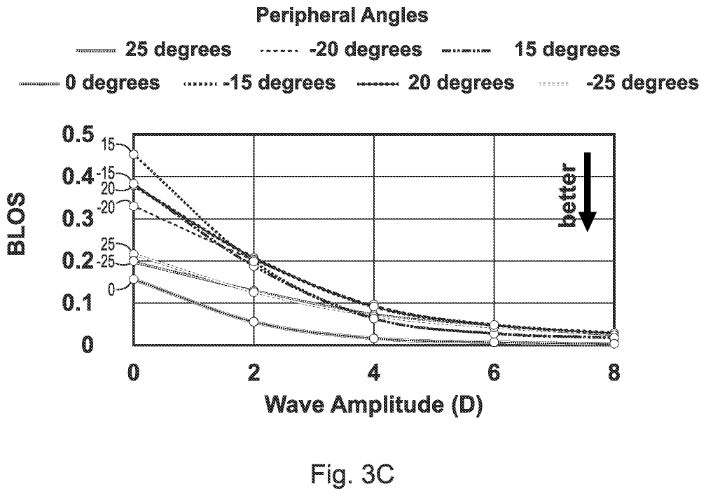

To show effects on performance of each of several parameters, performance was calculated for a given parameter as the given parameter is varied over a range while maintaining remaining parameters constant. To obtain data for each of the figures discussed below, Embodiment 1 was modeled by locating the lens of Embodiment 1 at a cornea of each of ninety eye models, each model specified using eye measurements made under photopic conditions from a non-presbyopic individual, and averaging the calculated outputs from each of the ninety modeled eyes. In particular, calculations were made for an object located at infinity using light at 589 nm and a lens having an index of refraction of 1.4 (at 589 nm). FIGS. 3A-3C, 4A-4C and 5A-5C show effects of changing wave amplitude, slope of average power in the peripheral zone and width of the no-modulation zone, respectively.

FIGS. 3A-3C are graphical illustrations showing the effects of changing wave amplitude on visual acuity, peripheral myopic defocus, and blur orientation slope (BLOS), respectively, over a range of 0-8 diopters of wave amplitude. In each of FIGS. 3A-3C, parameters other than wave amplitude are maintained as set forth in Embodiment 1.

FIG. 3A is graphical representation of logMAR acuity as function of wave amplitude. A decrease in normalized logMAR acuity of 0.02 corresponds to a loss of a single letter (i.e., a single optotype) on a standard Snellen chart. FIG. 3A shows that even at an amplitude of 8D, the amount of decrease in logMAR acuity corresponds to only a single letter on a line of a standard Snellen chart.

FIG. 3B is a graphical representation of peripheral myopic defocus as a function of wave amplitude for a series of three field angles. The values of peripheral myopic defocus corresponding to 0D of wave amplitude show the effective values of peripheral myopic defocus in the absence of periodic positive and negative deviations for each of three field angles; and values of peripheral myopic defocus corresponding to 8D of wave amplitude show the effective values of peripheral myopic defocus in the presence of relatively large periodic positive and negative deviations for each of the field angles. It is apparent that, for each of the field angles, the periodic variation provides a significant contribution to peripheral myopic defocus. A wave amplitude of 8D provides about 2.3 diopters of peripheral myopic defocus at a 25-degree field angle, about 1.4 diopters of peripheral myopic defocus at a 20-degree field angle, and about 1.2diopter of peripheral myopic defocus at a 15-degree field angle relative to a power profile lacking the positive slope in the peripheral power. Note that the field angles specified in FIGS. 3B and 3C (and other figures below) are measured relative to the cornea optical axis as the rays are incident on the outer surface of the ophthalmic optical system (e.g., the outer surface of a contact lens for systems including a contact lens or the outer surface of the cornea for systems including a corneal inlay).

FIG. 3C is a graphical representation of BLOS as a function of wave amplitude for a series of seven field angles. The values of BLOS corresponding to 0D of wave amplitude show the effective values of BLOS in the absence of periodic positive and negative deviations for the various angles; and values of BLOS corresponding to 8D of wave amplitude show the BLOS in the presence of relatively large periodic (positive and negative) deviations for each of the field angles. For all field angles, BLOS monotonically decreases as a function of increasing wave amplitude. The periodic deviations also provide the lens with extended depth of focus thereby significantly decreasing BLOS at 0° field.

Accordingly, it is apparent from FIGS. 3A-3C that, an increase in wave amplitude is effective at increasing peripheral defocus and decreasing BLOS but does not significantly compromise visual acuity.

FIGS. 4A-4C are graphical illustrations showing the effects of changing slope of average power in the peripheral zone on visual acuity, peripheral myopic defocus and BLOS, respectively, over a range of 0-6D/mm. In each of FIGS. 4A-4C, parameters other than slope of average power in the peripheral zone are maintained as set forth in Embodiment 1.

FIG. 4A is a graphical representation of visual acuity as function of slope of the average peripheral power. FIG. 4A shows that even at a slope of 6D/mm, the decrease in logMAR acuity is significantly less than a decrease corresponding to loss of a single letter on a line of a standard Snellen chart. Accordingly, it is apparent that an increase in slope of the average peripheral power does not significantly compromise visual acuity.

FIG. 4B is a graphical representation of peripheral myopic defocus as a function of the slope of average peripheral power for a series of three field angles. The values of peripheral myopic defocus corresponding to 0D/mm of slope of average peripheral power show the effective values of peripheral myopic defocus in the absence of positive slope in the peripheral power (i.e., the average peripheral power is equal to the average of the power in the central zone), and the values of peripheral myopic defocus corresponding to 6D/mm of slope of average power show the effective values of peripheral myopic defocus in the presence of a relatively large slope. It is apparent that, for each of the field angles, the slope of the average power provides a significant contribution to peripheral myopic defocus, particularly at larger field angles. A slope of 6D/mm provides about 3.6 diopters of peripheral myopic defocus at a 25-degree field angle, about 2 diopters of peripheral myopic defocus at a 20-degree field angle, and about 1 diopter of peripheral myopic defocus at a 15-degree field angle relative to a power profile lacking the positive slope in the peripheral power.

FIG. 4C is a graphical representation of BLOS as a function of slope of the average peripheral power for a series of seven field angles. The values of BLOS corresponding to 0D/mm of slope show the effective values of BLOS in the absence of slope of the average peripheral power; and values of BLOS corresponding to 6D/mm of slope show the BLOS in the presence of a relatively large slope of the average peripheral power. For all field angles, BLOS is substantially unaffected by slope of the average peripheral power.

Accordingly, it is apparent from FIGS. 4A-4C that, an increase in slope of average peripheral power is effective at increasing peripheral defocus and it does not significantly compromise visual acuity or affect BLOS.

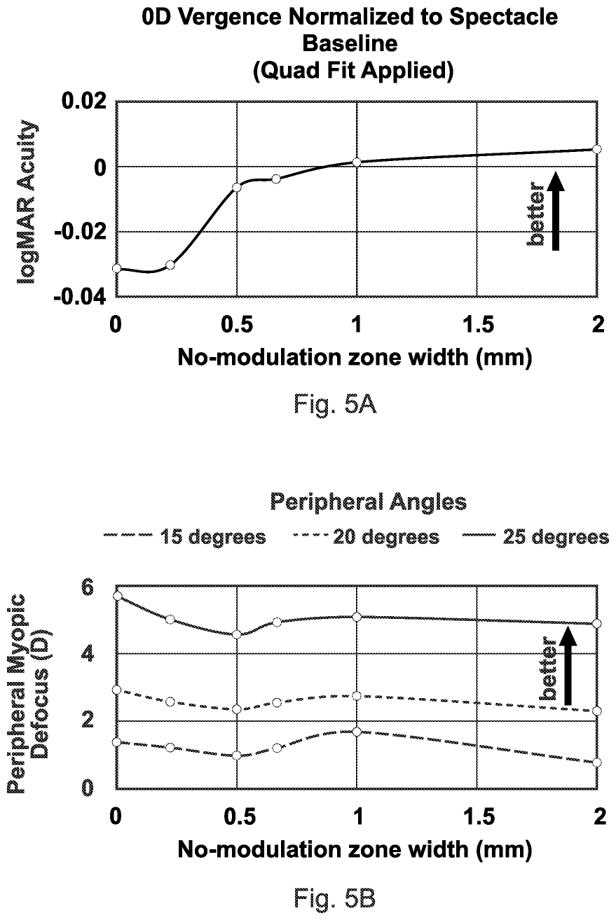

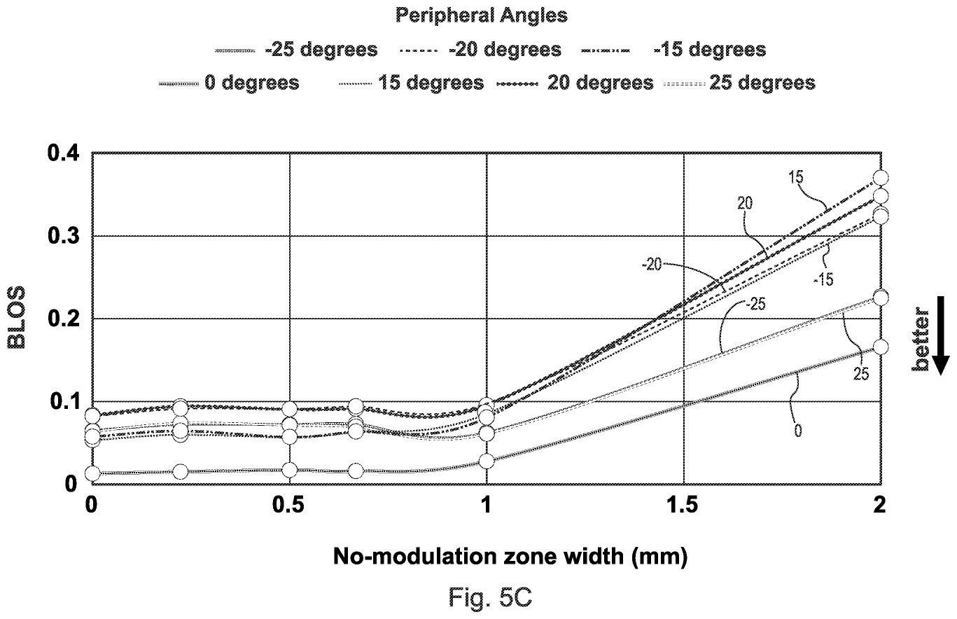

FIGS. 5A-5C show the effects of changing width (i.e., radius) of the portion of the central zone having no periodic deviation in power on visual acuity, peripheral myopic defocus, and BLOS, respectively, over a range of 0-2.0 mm of width. In each of FIGS. 5A-5C, parameters other than width of the portion of the central zone having no periodic deviation are maintained as set forth in Embodiment 1.

FIG. 5A is a graphical representation of acuity as a function of width of the portion of the central zone having no periodic deviation in power. Normalized visual acuity as a function of width of the portion of the central zone having no periodic deviation in power increases significantly until at about 0.5 mm of width (i.e., visual acuity in not compromised for widths greater than about 0.5 mm). FIG. 5A shows that, when the portion has a diameter of zero (i.e., the periodic deviations begin at the optical axis of the lens), visual acuity is affected with a loss of about 1.5 optotypes relative to peak acuity.

FIG. 5B is a graphical representation of peripheral myopic defocus as a function of width of the portion of the central zone having no periodic deviation in power, for a series of three field angles. FIG. 5B shows that, for all field angles, peripheral myopic defocus is fairly constant with some fluctuations across the illustrated range of values. The width has the largest impact on peripheral myopic defocus for values below 0.5 mm, with the greatest impact occurring at larger field angles. It is to be noted that the no modulation zone width does not affect peripheral myopic defocus to the extent that peripheral slope does (as shown in FIG. 4B). It is also to be noted that peripheral myopic defocus is monotonically increasing with increasing peripheral slope, while the effect of increasing width of the no-modulation zone is not monotonic.

FIG. 5C is a graphical representation of BLOS as a function of width of the portion of the central zone having no periodic deviation in power, for a series of seven field angles. FIG. 5C shows that the width of the portion of the central zone having no periodic deviation in power does not have a significant impact on BLOS at any of the seven field angles until the width exceeds 1 mm, after which BLOS increases significantly as a function of increasing width of the no-modulation zone.

It is apparent from FIGS. 5A-5C that the width of the portion of the central zone having no deviations impacts visual acuity and BLOS but does not significantly impact peripheral myopic defocus. Accordingly, in some instances, it is apparent that selecting a width of no-modulation zone of 0.5-1.0 mm is advantageous; although in other instances a width outside of this zone may be appropriate.

The width of the portion of the central zone having no deviations is typically selected to achieve optical acuity; although, the width can impact wearer comfort. Also, adding deviations to the central region (i.e., decreasing the width of the portion of the central zone having no deviations) may increase depth of focus that in turn may address eye strain due to possible under-accommodation in young myopes. Additionally, adding deviations to the central region adds the possibility of decreasing the stimulus to eye growth that results from the presence of deviations in the central zone, without impacting visual acuity.

Although the effects of 3 variables of a power profile were modeled, other variables of a profile (e.g., central zone radius (where peripheral zone radius is varied along with central zone radius to keep the lens radius constant) or frequency of the modulation of the power deviations) could similarly be modeled.

Lenses according to the present invention can be made of, for example, a silicone hydrogel and can be manufactured using any suitable technique such as cast molding or lathing.

Although various embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. An ophthalmic lens, comprising:
a central zone having a first region characterized by a substantially constant first optical power and a second region disposed radially outward of the first region having positive and negative deviations in power as a function of radial position, relative to the substantially constant first power; and
a peripheral zone disposed radially outward of the central zone, the peripheral zone having positive and negative deviations as a function of radial position, relative to an average optical power, the average optical power increasing as a function of radius from the substantially constant first optical power.

2. The lens of claim 1, wherein the substantially constant first optical power of the first region, the positive and negative deviations of the second region as a function of radius, and the positive and negative deviations of peripheral zone constitute a power profile, and
wherein the power profile has no discontinuities in power.

3. The lens of claim 1, wherein the diameter of the central zone is at least 2 mm.

4. The lens of claim 1, wherein the diameter of the central zone is at least 3 mm.

5. The lens of claim 1, wherein the central zone and the peripheral zone are rotationally symmetric.

6. The lens of claim 1, wherein the lens is contact lens.

7. The lens of claim 1, wherein the positive and negative deviations in power of at least one of the second region and the peripheral zone is periodic as a function of radius.

8. The lens of claim 1, wherein the area above the constant first power and the average power that is encompassed by the positive deviations is less than 20% different than the area below the constant first power and the average power that is encompassed by the negative deviations.

9. The lens of claim 1, wherein the deviation amplitude relative to the average optical power of the peripheral zone is equal to the deviation amplitude relative to the substantially constant first power in the second region.

10. The lens of claim 1, wherein the average optical power in the peripheral zone increases linearly.

11. The lens of claim 1, wherein the positive deviations and the negative deviations in the peripheral zone have an amplitude in the range of 0.5-12.0 diopters.

12. The lens of claim 1, wherein the positive deviations and the negative deviations in the second region and the peripheral zone are determined by variations in surface curvature.

13. The lens of claim 2, wherein the lens is contact lens.

14. The lens of claim 13, wherein the central zone and the peripheral zone are rotationally symmetric.

15. The lens of claim 14, wherein the diameter of the central zone is at least 2 mm.

16. The lens of claim 15, wherein the positive and negative deviations in power of at least one of the second region and the peripheral zone is periodic as a function of radius.

17. The lens of claim 16, wherein the area above the constant first power and the average power that is encompassed by the positive deviations is less than 20% different than the area below the constant first power and the average power that is encompassed by the negative deviations.

18. The lens of claim 17, wherein the positive deviations and the negative deviations in the peripheral zone have an amplitude in the range of 0.5-12.0 diopters.

19. The lens of claim 18, wherein the positive deviations and the negative deviations in the second region and the peripheral zone are determined by variations in surface curvature.

20. The lens of claim 19, wherein the average optical power in the peripheral zone increases linearly.
